(19) United States
(12) Patent Application Publication
(10) Pub. No.: US 2004/0064379 A1
(43) Pub. Date: Apr. 1, 2004

(54) Local availability of products and services on a sales user interface

(75) Inventors: Glen J. Anderson, Sioux City, IA (US); Russell F. McKnight, Sioux City, IA (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/260,195

(22) Filed: Sep. 30, 2002

(51) Int. Cl. G06F 17/60

(52) U.S. Cl. 705/27

(57) ABSTRACT

The present invention is directed to a system and method for local availability of products and services on a sales user interface. Through use of the present invention, availability of goods and corresponding services offered at a location near the user may be communicated to a consumer, thereby informing the consumer of desirable services and goods. A method for identifying services corresponding to a product available to a user based on user location may include monitoring user interaction with network navigation software operating on an information handling system. A product is identified based on the monitored user interaction with the network navigation software and a service corresponding to the identified product determined, the service determination based on user location.

### FIELD OF THE INVENTION

The present invention generally relates to the field of sales of products and services over a network, and particularly to local availability of products and services on a sales user interface.

### BACKGROUND OF THE INVENTION

With the advent of e-commerce, manufacturers are able to offer goods for sale to a wide range of consumers. However, when purchasing goods, many consumers desire to interact in person with the good in order to make a selection. In order to achieve this, often a consumer may travel to store location, which in many instances is not related to the Internet provider.

For example, a user may research and view pictures of a particular type of product at an Internet provider's web site. However, the user may venture to a store location, which while offering a similar type of good, is not the same good as offered by the Internet provider. Thus, the Internet provider may lose the sale due to the consumer's inability to physically interact with the good. Even in instances where the Internet provider has physical store locations to address these problems, the user may be unaware of the location, and thus still purchase the item from a different provider.

Thus, even with the availability of goods over the Internet, there is still an important role for physical store locations located conveniently to a consumer to provide desired goods and services related to the goods. Additionally, services may be offered which are tailored to the goods desired by the consumer which may greatly increase the consumer's enjoyment and productivity utilizing the good. However, the user may be unaware of these related services, and thus may not fully realize the advantages offered by the “click-and-mortar” business.

Therefore, it would be desirable to provide a system and method for local availability of products and services on a sales user interface.

### SUMMARY OF THE INVENTION

Accordingly, the present invention is directed to a system and method for local availability of products and services on a sales user interface. Through use of the present invention, availability of goods and corresponding services offered at a location near the user may be communicated to a consumer, thereby informing the consumer of desirable services and goods. In this way, potential consumers are notified of good and service availability, and are therefore more likely to avail themselves of the provider's goods and services.

In an aspect of the present invention, a method for identifying services corresponding to a product available to a user based on user location includes monitoring user interaction with network navigation software operating on an information handling system. A product is identified based on the monitored user interaction with the network navigation software and a service corresponding to the identified product determined, the service determination based on user location.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an embodiment of the present invention wherein a network environment offering a plurality of goods is navigated by a consumer to locate desired products;

FIG. 2 is an illustration of an embodiment of the present invention wherein a consumer utilizing network navigation software is offered a service corresponding to a selected product;

FIG. 3 is a flow diagram depicting an exemplary method of the present invention wherein a product, identified through monitored user interaction with network navigation software, is utilized to determine a service corresponding to the product available in a proximity to the user's location;

FIG. 4 is a diagram illustrating an embodiment of the present invention wherein service information related to a variety of goods is obtained from disparate network sites;

FIG. 5 is a flow diagram illustrating an exemplary method of the present invention wherein services are queried from multiple providers, the query performed based on location and corresponding product;

FIG. 6 is a flow diagram illustrating an exemplary method of the present invention wherein notifications are given if a product available from a first provider is available through a specified provider; and

FIG. 7 is a flow diagram illustrating an exemplary method of the present invention wherein similar service and product options, including products offered in bundles, are output to a user.

### DETAILED DESCRIPTION OF THE INVENTION

Reference will now be made in detail to the presently preferred embodiments of the invention, examples of which are illustrated in the accompanying drawings.

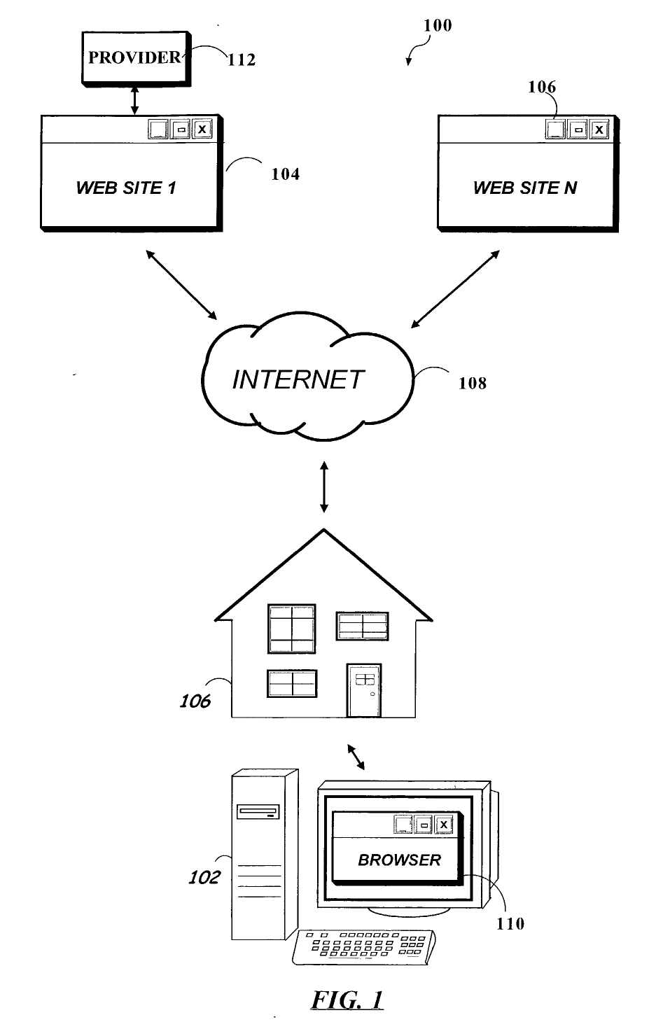

Referring generally now to FIGS. 1 through 7, exemplary embodiments of the present invention are shown. Even though there are a wide variety of goods available over the Internet, in many instances consumers still desire to physically interact with the goods, such as to judge quality of manufacture, size, appearance, and the like. Thus, there is still an important role for physical store locations located conveniently to a consumer to provide desired goods and services related to the goods.

Additionally, services may be offered which are tailored to the goods desired by the consumer. However, the user may be unaware of these related services, and thus may not fully realize the advantages offered by the “click-and-mortar” business. Through use of the present invention, availability of goods and corresponding services offered at a location near the user may be communicated to a consumer, thereby informing the consumer of desirable services and goods. In this way, potential consumers are notified of good and service availability, and are therefore more likely to avail themselves of the provider's goods and services.

Referring now to FIG. 1, an embodiment 100 of the present invention is shown wherein a network environment offering a plurality of goods is navigated by a consumer to locate desired products. A consumer may utilize a information handling system, such as a personal computer 102, convergence device, digital information appliance, personal digital assistant, Internet appliance, and the like, to access web sites 104 & 106 from the consumer's home 106 over a network connection, such as the Internet 108. The personal computer may include a browser 110 which enables the consumer to navigate the vast options available through the Internet 108.

For example, a consumer may access a first web site 104 supplied by a retail provider 112. The provider 112 may have a physical location that would enable a user, when finding a desirable good, to interact with the good before purchase. Additionally, services may be provided which correspond to the good, which may make the good and services as a combination more desirable to the consumer. Through use of the present invention, a user is notified of corresponding services offered in relation to goods desired by the consumer near the consumer's location. Thus, a consumer may be made aware of the availability of services and goods at a location near the consumer, and thus promote the likelihood that the consumer will purchase the good, interact with the good at the provider's location, avail themselves of related services, and the like.

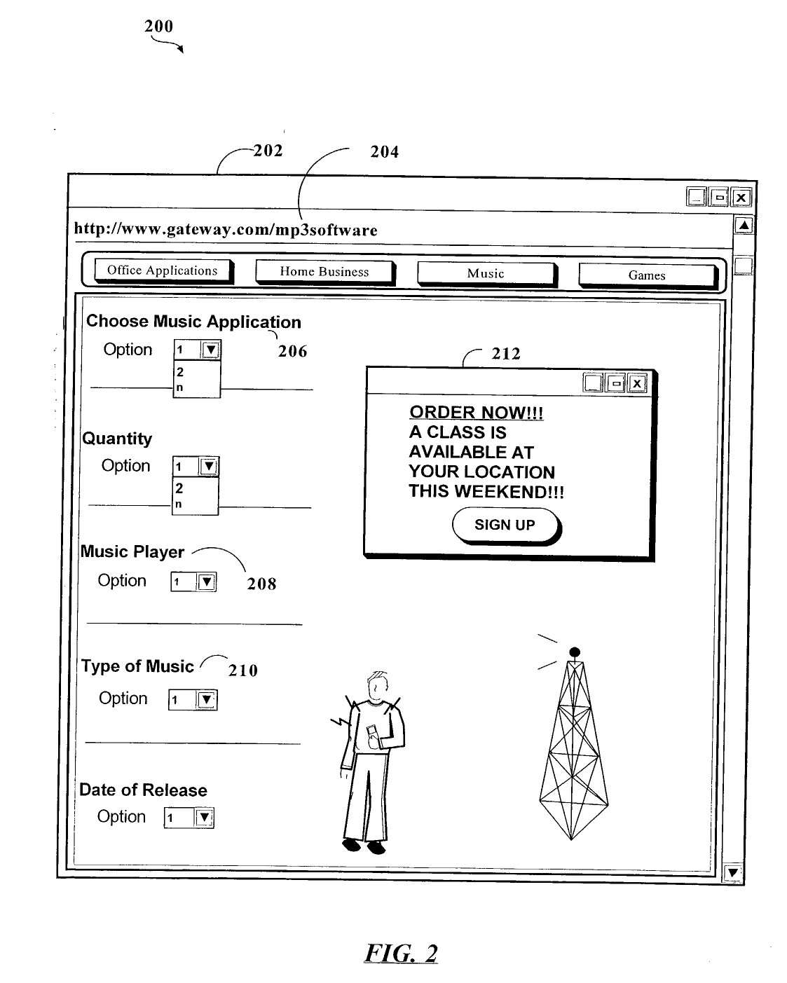

Referring now to FIG. 2, an embodiment 200 of the present invention is shown wherein a consumer utilizing network navigation software is offered a service corresponding to a selected product. A consumer, utilizing network navigation software, such as a browser 202, accesses a network site 204. The network site 204 includes a variety of goods available for purchase, in this instance musical goods, including music applications 206, music players 208 and music titles 210. A user may interact with the various goods, such as by positioning a cursor over the item, accessing different views of the good, selecting quantities, placing the item in a shopping cart, and the like as contemplated by a person of ordinary skill in the art.

Through use of the present invention, user interaction with a good may be monitored and products identified based on the monitored interaction. A corresponding service may be found based on the user's location and the user notified of the availability. For example, an additional window 212 may be displayed having a display of data indicated the available service, the particular location of the available corresponding service, offer to sign-up the user for the service when purchasing the good, give directions to the location, and the like without departing from the spirit and scope of the present invention. In this way, a “click-and-mortar” provider may realize a synergy between accessibility of a network site and benefits of physical locations and provide these benefits to the consumer.

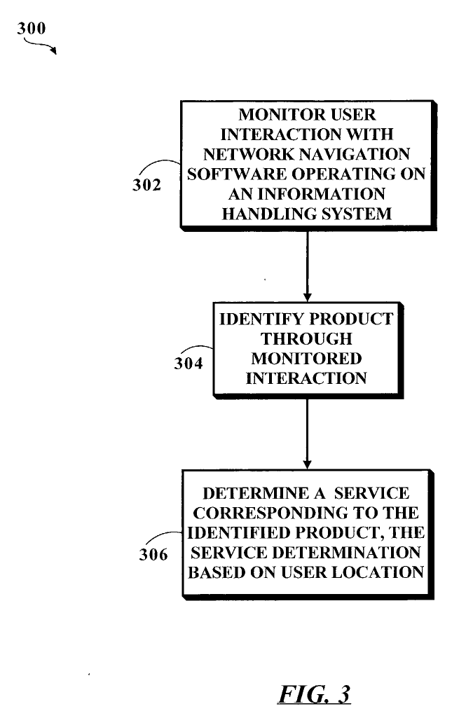

Referring now to FIG. 3, an exemplary method 300 of the present invention is shown wherein a product identified through monitored user interaction with network navigation software is utilized to determine a service corresponding to the product available in a proximity to the user's location. A user may employ an information handling system having a network connection device to access a network and navigate through the network using network navigation software. User interaction with the network navigation software operating on the information handling system is monitored 302. Monitoring may include tracking network sites visited, data entry, cursor movement in relation to displayed item, accessible links based on cursor movement, names of links, and the like. A product is identified through the monitored interaction 304, such as by placing the product in a shopping cart, accessing multiple views of the products, accessing information related to the product, and the like.

A corresponding service is determined for the identified product, the service determination based on user location 306. For instance, a user may select software and a service found for instructing the user on how to operate the software offered at a location near the user. The user's location may be determined utilizing a variety of methods, such as accessing an identifier of user location including zip code, postal address, area code of phone number, determined utilizing a position determining device, and the like. Thus, a user may be provided with notifications of services related to products which are offered in the user's proximity. Such proximity may comfort the user, from what is considered by some to be the isolation of the consumer from the provider, by indicating to the user of the availability of product and services by the provider at the user's locale.

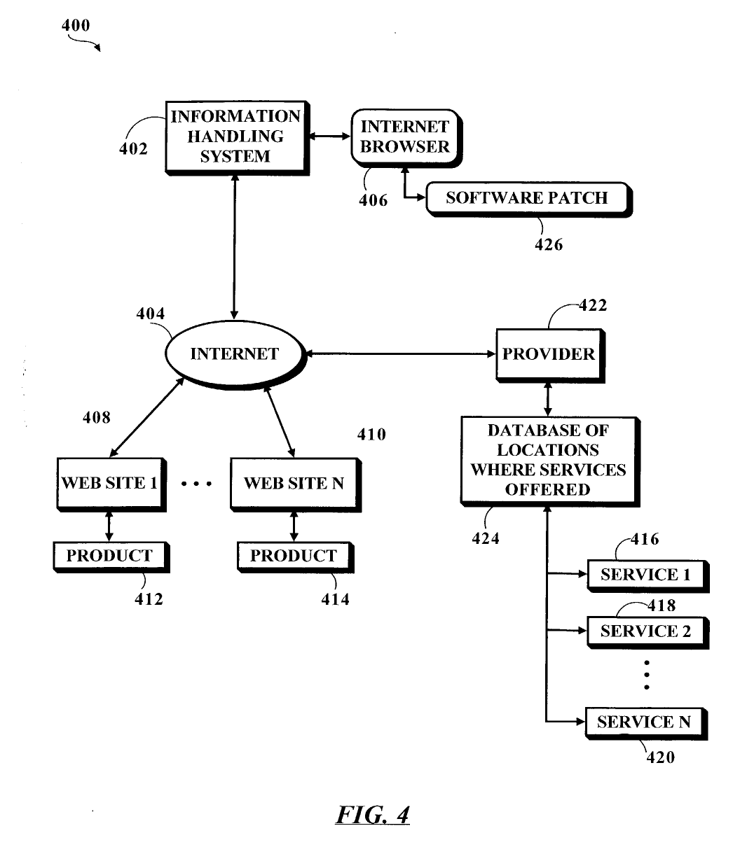

Referring now to FIG. 4, an embodiment 400 of the present invention is shown wherein service information related to a variety of goods is obtained from disparate network sites. A user when navigating through network sites, such as web sites and the like, may access a multitude of providers to obtain information regarding a desired good. In such instances, the present invention may still notify a user of corresponding services.

For example, an information handling system 402 may include a network connection device suitable for accessing a global network, such as the internet 404. To navigation through the multitude of network sites, network navigation software may be utilized, such as an internet browser 406. The internet browser 406 enables a user to progress through the variety of web sites 408 & 410 and access desired products 412 & 414 at the web sites 408 & 410.

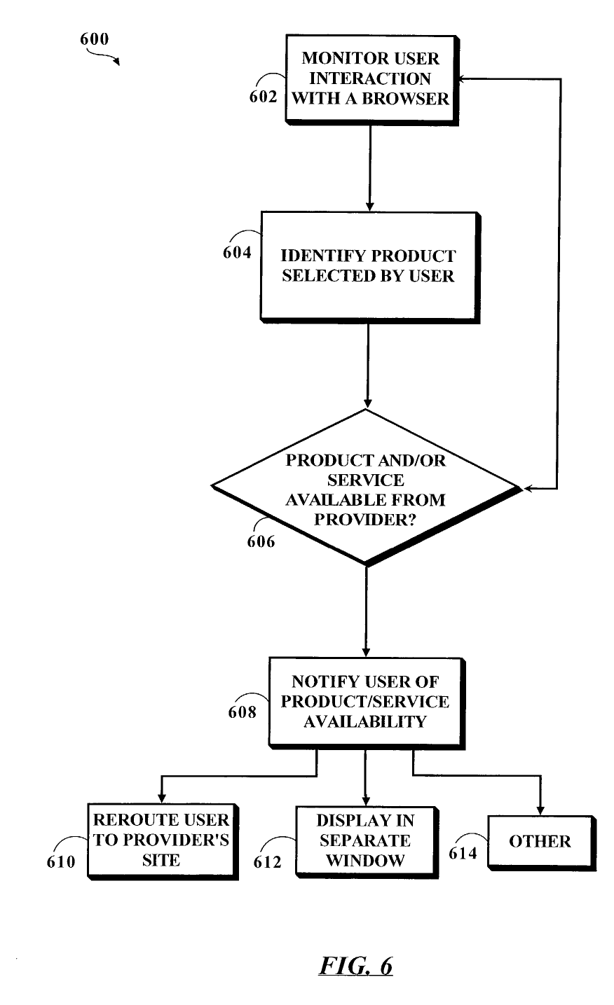

User interaction with the web sites 408 & 410 and the included products 412 & 414 are monitored by the present invention and products identified 412 & 414. Services 416, 418 & 420 corresponding to the products 412 & 414 may be identified through a database of locations of offered services 424, even if the services are offered by a provider 422 which is different from the providers of the web sites 408 & 410. Thus, services may be provided even for purchasers of goods from other locations, as will be discussed in greater detail in relation to FIG. 6. To promote operability with legacy software, the present invention may be provided as a “patch” 426 to a preexisting browser 406.

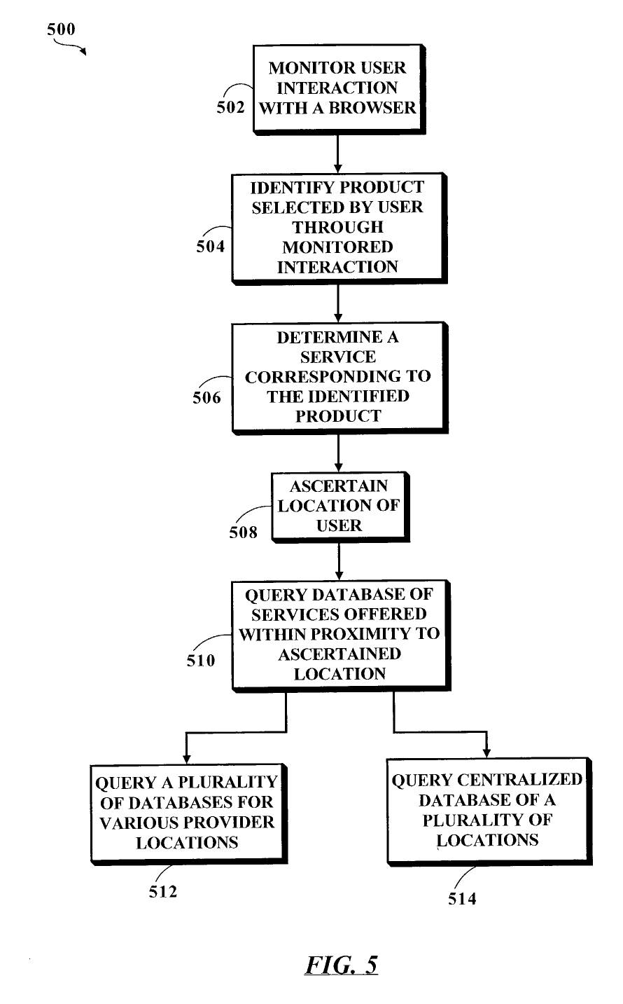

Referring now to FIG. 5, an exemplary method 500 of the present invention is shown wherein services are queried from multiple providers, the query performed based on location and corresponding product. User interaction with a browser is monitored 502 and a product selected by user is identified 504. A service is determined which corresponds to the identified product 506. The location of the user is then ascertained 508. Ascertaining the user's location may include utilization of a position determining device such as a GPS; stored entry of a location by the user, such as zip code, postal address, area code, and the like; as well as like methods as contemplated by a person of ordinary skill in the art.

A database of services offered is queried to determine a service offered within a desired proximity to the user's location 510. For instance, multiple service providers may be queried, with closer providers being queried first 512. A centralized database of a plurality of locations may also be queried 514, such as a database including multiple provider locations of a retail chain, and the like. Thus, services may be determined within varying proximities to a user. Although decreasing proximity has been discussed, it should be apparent that a variety of criteria may be utilized in accordance with the present invention.

Referring now to FIG. 6, an exemplary method 600 of the present invention is shown wherein notifications are given if a product available from a first provider is available through a specified provider. A user may prefer to purchase products from providers with which the user has had past experience. Therefore, in this embodiment, a specified provider, such as a preferred provider, is checked for product and/or service availability of a product offered by a different provider.

For example, a user's interaction with a browser is monitored 602 and a product selected by the user, as determined through the monitored interaction, is identified 604. Availability of the product and/or service by a specified provider is checked 606, if not available, the system continues to monitor user interaction 602.

However, if the product and/or service is available from the provider 606, the user is notified of product/service availability 608. Notifying the user may include rerouting the user to the specified provider's site 610, displaying the available product/service and related data in a separate window 612, or other like methods 614 as contemplated by a person of ordinary skill in the art.

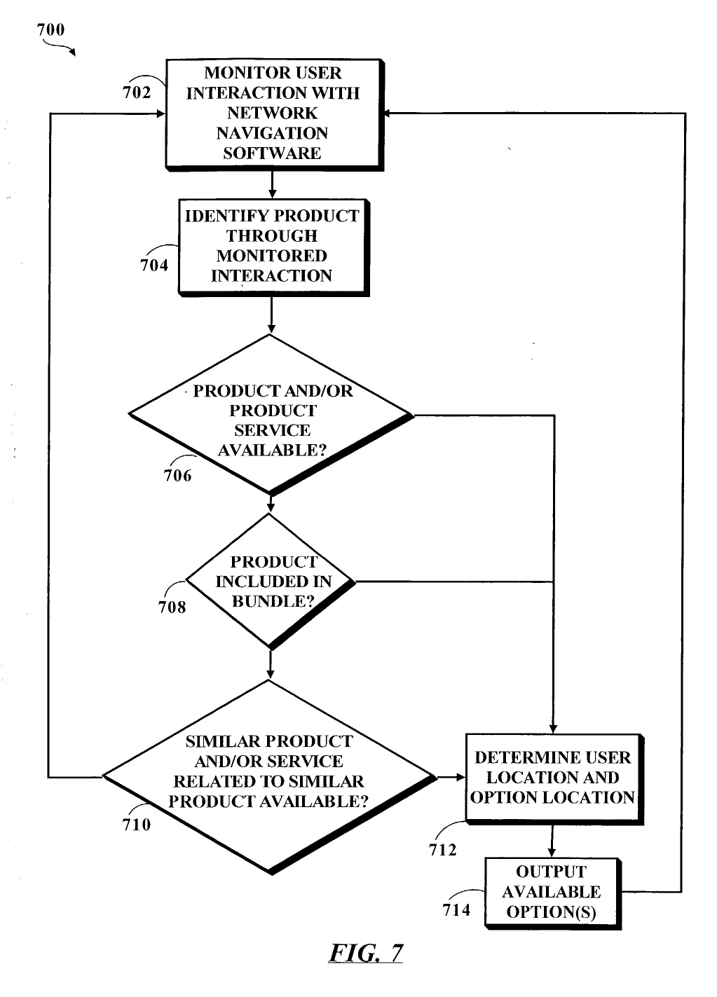

Referring now to FIG. 7, an exemplary method 700 of the present invention is shown wherein similar service and product options, including products offered in bundles, are output to a user. In some instances, a product selected by a user may be a subset of a bundle of products offered by a provider. For instance, an application may be included in a suite, and training may be offered for how to use the suite. Additionally, similar products may be offered, which, while not identical, may be desirable to a consumer.

For instance, user interaction with network navigation software may be monitored 702 and a product identified through the monitored interaction 704. A first determination is made if the product and/or corresponding service is available from the provider 706. If not, an additional determination is made as to whether the product is included in a product bundle 708. If a corresponding product bundle is not found, a determination is made for similar products and/or services related to the similar product available 710. If the product, product bundle or similar product/service is found, the user's location is determined 712 and the available options output 714.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

Although the invention has been described with a certain degree of particularity, it should be recognized that elements thereof may be altered by persons skilled in the art without departing from the spirit and scope of the invention. One of the embodiments of the invention can be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc for utilization in a CD-ROM drive and/or digital video disc (DVD) drive, a compact disc such as a compact disc-rewriteable (CD-RW), compact disc-recordable and erasable; a floppy disk for utilization in a floppy disk drive; a floppy/optical disc for utilization in a floppy/optical drive; a memory card such as a memory stick, personal computer memory card for utilization in a personal computer card slot, and the like. Further, the set of instructions can be stored in the memory of an information handling system and transmitted over a local area network or a wide area network, such as the Internet, when desired by the user.

Additionally, the instructions may be transmitted over a network in the form of an applet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for identifying services corresponding to a product available to a user based on user location, comprising:
monitoring user interaction with network navigation software operating on an information handling system;
identifying a product based on the monitored user interaction with the network navigation software; and
determining a service corresponding to the identified product, the service determination based on user location.

2. The method as described in claim 1, wherein identifying the product includes at least one of placing the product in a shopping cart, selecting the product by a user, manipulating the product with a cursor control device and scanning a network site for available products.

3. The method as described in claim 1, wherein determining includes accessing at least one database including identifiers for service availability at a location.

4. The method as described in claim 3, wherein the at least one database is configured as at least one of a centralized database and a plurality of databases located at a plurality of network sites.

5. The method as described in claim 1, further comprising ascertaining the user's location, wherein ascertaining includes at least one of accessing a stored indication of user location; and obtaining location from a location determining device without intervention by the user.

6. The method as described in claim 1, wherein the network navigation software includes an Internet browser.

7. The method as described in claim 1, wherein the user interacts with a first provider's network site having the identified product, when the identified product is available from a second provider, the user is notified of the availability of at least one of the identified product and a service corresponding to the identified product from the second provider.

8. The method as described in claim 7, wherein the second provider is previously specified.

9. The method as described in claim 1, wherein determining includes arriving at a similar product to identified product, arriving at a service corresponding to a similar product, and arriving at a service corresponding to a bundle including the product.

10. An information handling system, comprising:
a memory suitable for storing a program of instructions;
an input/output device suitable for receiving and outputting data;
a network connection device suitable for communicatively coupling the information handling system to a network over a network connection; and
a processor suitable for performing a program of instructions, the processor communicatively coupled to the memory, the network connection device, and the input/output device, wherein the program of instructions configures the processor to
monitor user interaction with network navigation software operating on an information handling system, the network navigation software configuring the information handling system to enable the user to interact with a network site over a network connection;
identify a product based on the monitored user interaction with the network site; and
determine a service corresponding to the identified product, the service determination based on user location.

11. The information handling system as described in claim 10, wherein identifying the product includes at least one of placing the product in a shopping cart, selecting the product by a user, manipulating the product with a cursor control device and scanning a network site for available products.

12. The information handling system as described in claim 10, wherein determining includes accessing at least one database including identifiers for service availability at a location.

13. The information handling system as described in claim 12, wherein the at least one database is configured as at least one of a centralized database and a plurality of databases located at a plurality of network sites.

14. The information handling system as described in claim 10, further comprising ascertaining the user's location, wherein ascertaining includes at least one of accessing a stored indication of user location; and obtaining location from a location determining device without intervention by the user.

15. The information handling system as described in claim 10, wherein the network navigation software includes an Internet browser.

16. The information handling system as described in claim 10, wherein the user interacts with a first provider's network site having the identified product, when the identified product is available from a second provider, the user is notified of the availability of at least one of the identified product and a service corresponding to the identified product from the second provider.

17. The information handling system as described in claim 16, wherein the second provider is previously specified.

18. The information handling system as described in claim 10, wherein determining includes arriving at a similar product to identified product, arriving at a service corresponding to a similar product, and arriving at a service corresponding to a bundle including the product.

19. A system for identifying services corresponding to a product available to a user based on user location, comprising:
means for monitoring user interaction with network navigation software operating on an information handling system;
means for identifying a product based on the monitored user interaction with the network navigation software received from the monitoring means; and
means for determining a service corresponding to the identified product received from the identifying means, the service determination means utilizing user location.

20. The system as described in claim 19, wherein identifying the product includes at least one of placing the product in a shopping cart, selecting the product by a user, manipulating the product with a cursor control device and scanning a network site for available products.

21. The system as described in claim 19, wherein determining includes accessing at least one database including identifiers for service availability at a location.

22. The system as described in claim 21, wherein the at least one database configured as at least one of a centralized database and a plurality of databases located at a plurality of network sites.

23. The system as described in claim 19, further comprising ascertaining the user's location, wherein ascertaining includes at least one of accessing a stored indication of user location and obtaining location from a location determining device without intervention by the user.

24. The system as described in claim 17, wherein the network navigation software includes an Internet browser.

25. The system as described in claim 19, wherein the user interacts with a first provider's network site having the identified product, when the identified product is available from a second provider, the user is notified of the availability of at least one of the identified product and a service corresponding to the identified product from the second provider.

26. The system as described in claim 25, wherein the second provider is previously specified.

27. The system as described in claim 19, wherein determining means includes arriving at a similar product to identified product, arriving at a service corresponding to a similar product, and arriving at a service corresponding to a bundle including the product.
